(19) United States
(12) Patent Application Publication
(10) Pub. No.: US 2003/0067910 A1
(43) Pub. Date: Apr. 10, 2003

(54) Voice conferencing over a power line

(76) Inventors: Kaveh Razazian, Alisa Viejo, CA (US); Christina K. Chan, Northridge, CA (US); Farshad Meshkinpour, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/233,165

(22) Filed: Aug. 30, 2002

Related U.S. Application Data
(60) Provisional application No. 60/316,085, filed on Aug. 30, 2001.

(51) Int. Cl. H04L 12/66

(52) U.S. Cl. 370/352

(57) ABSTRACT

In one embodiment, a mechanism for multicast operations on a HomePlug frame, including voice information, that is being transmitted over a power line. Such multicasting is accomplished by placing a specified multicast address in a destination address field of the HomePlug frame. The specified multicast address corresponds to all adapters and a voice channel associated with a specific logical group.

### CROSS REFERENCE TO RELATED APPLICATION

This application claims the benefit of priority of U.S. Provisional Application No. 60/316,085, filed Aug. 30, 2001.

### FIELD

The invention relates to the field of networking. More specifically, the invention relates to a system and method for enabling voice conferencing over power line(s).

### GENERAL BACKGROUND

Over the last few years, there has been a growing demand for home networking. In fact, efforts have been made to develop a high-speed home network using alternating current (AC) power line wiring as its medium. Recently, the HomePlug Powerline Alliance developed a specification that designs the functions, operations and interface characteristics for nodes to communicate over AC power lines. However, this specification, referred to as the “HomePlug 1.0 Specification” dated Jun. 30, 2001, merely addresses the transport of data and does not address the transport of voice packets, telephony signals and other types of information over these power lines. Also, the HomePlug's 1.0 Specification fails to address the need of multicast addressing in order to reduce data bandwidth usage at the centralized access point and/or at each adapter.

It is noted that conventional voice conferencing schemes fail to optimize data bandwidth usage. For instance, if voice conferencing is performed at a centralized access point, data bandwidth usage is approximately equal to 2 ×(number of users)×(data rate). If voice conferencing is conducted at each adapter, however, the data bandwidth usage is approximately equal to (number of users)×(number of users −1)×data rate. However, these levels of usage clearly do not optimize bandwidth efficiency.

### BRIEF DESCRIPTION OF THE DRAWINGS

The features and advantages of certain embodiments of the invention will become apparent from the following detailed description of the invention in which:

FIG. 1 is an exemplary block diagram of an embodiment of a network employing the invention.

FIG. 2 is an exemplary block diagram of a voice packet routed over a voice channel.

FIG. 3 is an exemplary block diagram of the network of FIG. 1 segregated into multiple logical groups.

FIG. 4 is an exemplary block diagram of a comparison process performed at a MAC layer of a node to determine if a HomePlug frame having a multicast address in the destination address field is intended for that node.

### DETAILED DESCRIPTION

Herein, an exemplary embodiment of the invention relates to a system and method for enabling the transportation of voice and telephony signals from a centralized access point to one or more adapters over a power line. The embodiment described herein is not exclusive; rather, it merely provides a thorough understanding of the invention. Also, well-known circuits and logical interconnections are not set forth in detail in order to avoid unnecessarily obscuring the invention.

In the following description, certain terminology is used to describe features of the invention. For example, a “node” is any equipment that transports information over a power line. Such transport may be in accordance with current or future specifications such as the HomePlug 1.0 Specification published on or around Jun. 30, 2001, although other transport protocols may be followed. Examples of different types of nodes include, but are not limited to an adapter or a centralized access point “CAP” (e.g., a gateway and/or bridge). The node is usually coupled to a power line through placement of a two-prong or three-prong plug into a wall socket of a dwelling. A “power line” is generally defined as a medium normally carrying nominal alternating current (AC) voltages. These AC voltages may range from approximately 120 volts (V) to 240V. A “logical group” is defined as a collection of nodes that are commonly addressed to receive voice signaling over a particular voice channel.

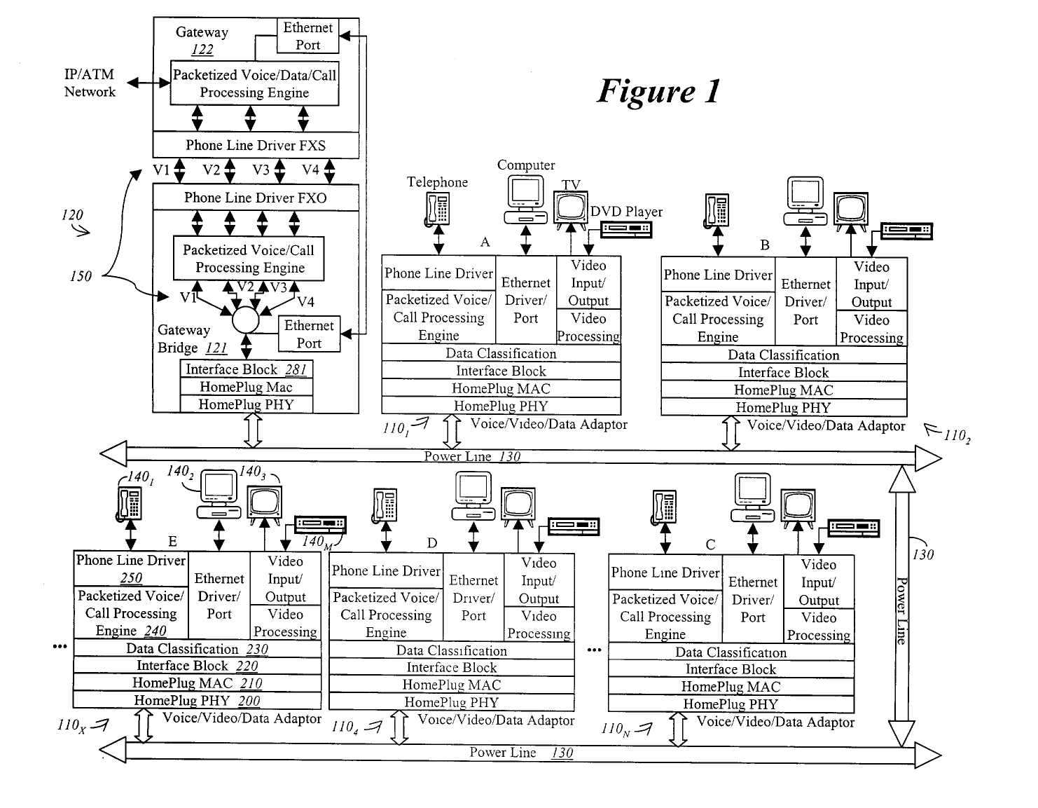

Referring to FIG. 1, an exemplary block diagram of an illustrative embodiment of a network 100 employing the invention is shown. The network 100 comprises a plurality of media adapters 110₁-110_{N} and a centralized access point (CAP) 120 coupled together through a power line 130. As shown, each adapter 110₁ . . . 110_{N} may be coupled to one or more (M) peripheral devices 140₁-140_{M} such as a telephone 140₁, a computer 140₂, a monitor 140₃ (e.g., cathode ray tube “CRT,” television, etc.) or even a digital video disc (DVD) player 140_{M}.

Any adapter 110_{X} (where X≧1) includes a two or three prong plug that can be inserted into a wall socket. This provides necessary coupling to the power line 130. In addition, the adapter 110_{X} further includes a connector that enables communications with the peripheral devices 140₁-140_{M}. The connector may be adapted with one or more connection ports such as, for example, RJ-11 jack(s), serial port(s) such as Universal Serial Bus (USB), parallel port(s), or any combination thereof. These connection ports enable a cable connection between that port and one of the peripheral devices 140₁, . . . , 140_{M}. It is contemplated that the connector may also be adapted as a wireless transceiver to support wireless communications with one or more of the peripheral device 140₁, . . . , 140_{M} in accordance with a wireless communication protocol (e.g., Bluetooth, HyperLAN2, IEEE 802.11, etc.)

A logical representation of each adapter (e.g., adapter 110₁) is further shown in FIG. 1. In particular, for this embodiment, the adapter 110₁ includes a physical (PHY) layer 200, a medium access controller (MAC) layer 210, an interface block 220, and a data classification block 230. In general, the PHY layer 200 features circuitry and software that support electrical and mechanical connections to the power line 130. These electrical or mechanical connections may be in accordance with the HomePlug standard described above. The PHY layer 200 further supports digital-to-analog conversion, analog-to-digital conversion, modulation such as orthogonal Frequency Division Multiplexing (OFDM) and/or error correction.

The MAC layer 210 is generally responsible for segmentation, reassembly and transport of frames such as frames in accordance with current or future HomePlug specifications through higher layer levels of the adapter 110₁. The MAC layer 210 further enables voice conferencing by supporting unicast and multicast address insertion and recognition for outgoing HomePlug frames and incoming HomePlug frames, respectively. Optionally, the MAC layer 210 may be used to identify the information type contained in the incoming HomePlug frame.

The interface block 220 is normally responsible for identifying the information type contained in the incoming HomePlug frame received over the power line 130. In addition, the interface block 220 is responsible for controlling the data classification block 230 to route voice signaling to a packetized voice call processing engine 240 and phone line driver 250, which control the operations and adjust the voice signals for receipt and transmission by the telephone 140₁. The voice call processing engine 240 features a table (or counter) that maintains the number of media adapters that are OFF-HOOK and associated with a logical group of which the adapter is a member. This table (or counter) is periodically checked and removes or decremented any of the telephones 140₁ have been hung up (i.e., ON-HOOK). After voice communication is established, it is dropped only after none of the telephones associated with the logical group are now in usage (OFF-HOOK).

As further shown in FIG. 1, the CAP 120 comprises a gateway bridge 121 and a gateway 122. The gateway bridge 121 interconnects the plurality of adapters 110₁-110_{N} to the gateway 122 which is in communication with another network such as a wide area network (WAN) 123 or a local area network (LAN). Herein, the voice signals are processed by the gateway bridge 121.

The bridge gateway 121 and gateway 122 provide a bi-directional WAN-to-LAN or LAN-to-LAN interface to route voice, video and data to and from each adapter using the power lines 130 in accordance with HomePlug standard as a transport media. In this embodiment, each voice channel (V1-V4) 150 can be assigned to one or several adapters. Each adapter 110_{X} supports an existing analog handset and all class 1 and class 2 facsimile devices. All adapters 110₁-110_{N} belong to a voice channel that supports conference calling (1 voice channel enables communications with an external source—the rest support internal communications within the network 100).

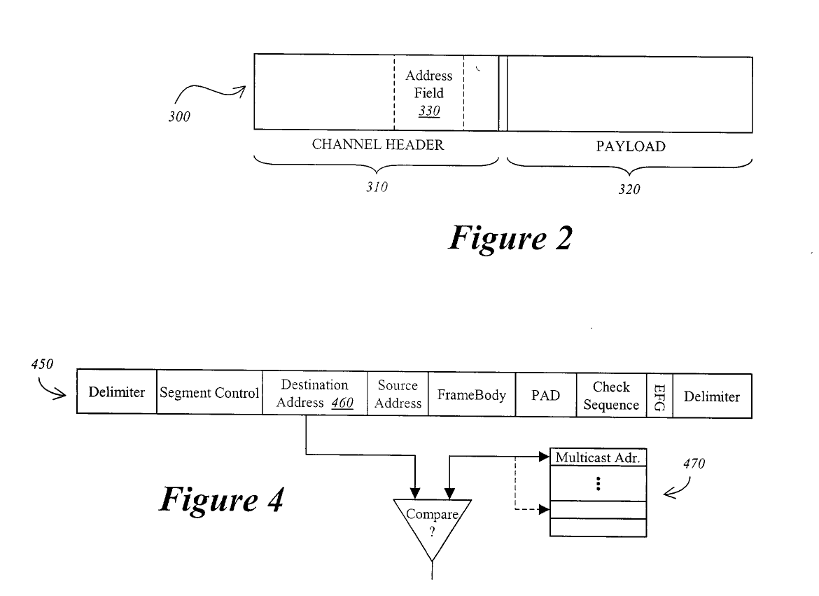

Referring now to FIG. 2, an exemplary block diagram of a voice packet used for voice transmission over voice channels supported by the CAP 120 is shown. Normally, a voice channel packet 300 comprises a channel header 310 and payload 320. The payload 320 includes bits representative of voice signals. The header 310 includes an address field 330 that specifies which adapters 110₁, . . . , 110_{N} to which the voice is intended.

Conference calls for network 100 are handled using group addressing at the MAC layer (referred to as either “multi-destination addressing” or “multicast addressing”). In multicast addressing, a voice channel and one or more adapters may be configured as a single logical group. Because of network design simplicity, each logical group can support at least twelve (12) media adapters unlike conventional voice conferencing systems that support up to six (6) telephones. This may be accomplished by specifying within the address field 330 of the channel header 310 which adapters 110₁, . . . , and/or 110_{N} are associated with that voice channel (V1-V4).

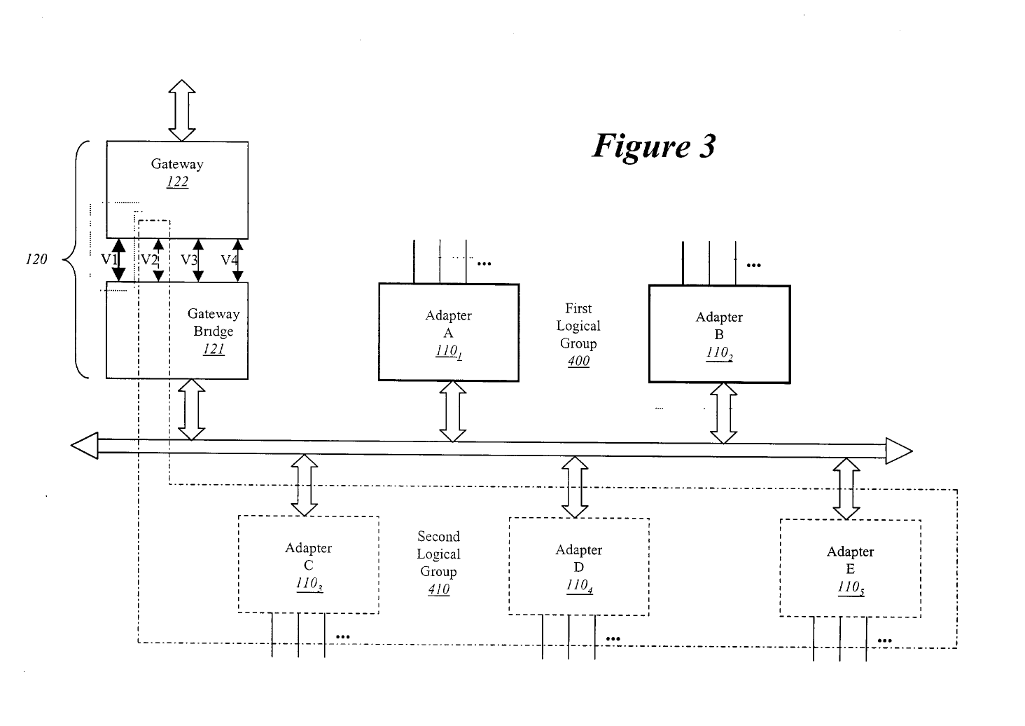

For example, as shown in FIG. 3, an exemplary block diagram of the network 100 of FIG. 1 segregated into multiple logical groups is shown. As an illustrative example, a first logical group 400 {V1, A, B} may be configured as a voice channel V1 with adapters (A&B) 110₁ and 110₂. The communication path of this logical group 400 is represented by darkened, solid lines. A logical group 410 {V2, C, D, E} can be configured as voice channel V2 with adapters (C, D & E) 110₃, 110₄ and 110₅. The communication path of this logical group 410 is represented by darkened, dashed lines.

Each logical group features a voice channel and any number of adapters. It is contemplated that an adapter 110_{X} can be a member of multiple logical groups. As shown, for this illustrative logical group configuration, the voice channel Vi can provide a ring signal to adapters 110₁ and 110₂ as well as voice channel V2 can provide ring signals to adapters 110₃, 110₄ and 110₅. Moreover, one or all users who are sharing the same logical group can talk simultaneously or concurrently through respective adapter(s) 110_{X} over the power lines 130.

For this embodiment, referring now to FIG. 4, the CAP 120 and adapters 110₁-110_{N} are multicasting HomePlug frames 450 with a specified multicast address that is placed in a destination address field 460 and corresponds to a particular logical group. Of course, such multicasting is generally referred to as a “broadcast” where all adapters are part of the same logical group. HomePlug frames 450 arriving at each node will be recognized and processed if the multicast address placed in the destination address field 460 matches an address contained in an address table in a HomePlug MAC group address table 470 stored at that node. Such comparison of the incoming destination address with address(es) in table 470 is performed by the MAC layer of each node.

The admitted packets will be differentiated whether it is voice, data or video at the interface block. These packets are routed to voice, video processing engine and Ethernet port through data bridge router sections accordingly. One exception is that caller ID is passed through and placed on the power line for access by all telephones without demodulation at the gateway bridge.

As a result of multicast addressing technique, data bandwidth usage drops to be approximately equal to the following: (number of users x data rate). Also, voice over HomePlug techniques emulate multiple analog phones that are connected to the same phone line at home but provides greater flexibility of use and adaptive features to handle voice, video and data.

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. A system comprising:
a power line;
a centralized access point;
a plurality of telephones; and
a plurality of adapters coupled together over the power line and each coupled to at least one of the plurality of telephones, the plurality of adapters being segregated into at least two logical groups each associated with a unique voice channel and at least one of the plurality of adapters, wherein
operations are performed by one of the central access point and the plurality of adapters on a frame, including voice information, to be transmitted over the power line with a specified multicast address placed in a destination address field of the frame that corresponds to one of the at least two logical groups.

2. The system of claim 1, wherein the power line carries alternating current ranging from approximately 120 volts to 240 volts.

3. The system of claim 1 wherein at least one adapter of the plurality of adapters comprises a physical layer to support mechanical and electrical connections to the power line; and
a medium access control (MAC) layer in communication with the physical layer to insert the specified multicast address in the destination address field of the frame before providing to the physical layer for transfer onto the power line.

4. The system of claim 1, wherein at least one adapter of the plurality of adapters comprises a Medium Access Control (MAC) layer to determine whether information contained in the frame arriving at the at least one adapter node is processed by the at least one adapter node by checking whether the multicast address placed in the destination address field of the frame matches an address contained in an address table stored in the at least one adapter.

5. The system of claim 1, wherein the centralized access point comprises:
a gateway supporting communications with a network; and
a gateway bridge in communication with the gateway over a plurality of voice channels including the voice channels associated with the at least two logical groups.

6. The system of claim 1, wherein the specified multicast address is unique to the one of the at least two logical groups.

7. The system of claim 1, wherein one of the plurality of adapters may be a member of all of the at least two logical groups.

8. A system comprising:
a power line;
a centralized access point; and
a plurality of adapters coupled together over the power line, the plurality of adapters being segregated into at least two logical groups each associated with a unique voice channel and at least one of the plurality of adapters, wherein
operations are performed by the centralized access point on a frame, including voice information, to be transmitted over the power line with a specified multicast address placed in a destination address field of the frame that corresponds to all adapters associated with one of the at least two logical groups.

9. The system of claim 8, wherein the power line carries alternating current ranging from approximately 120 volts to 240 volts.

10. The system of claim 8, wherein a gateway bridge of the centralized access point comprises:
a physical layer to support mechanical and electrical connections to the power line; and
a medium access control (MAC) layer in communication with the physical layer to insert the specified multicast address in the destination address field of the frame before providing to the physical layer for transfer onto the power line.

11. The system of claim 8, wherein at least a first adapter of the plurality of adapters comprises a Medium Access Control (MAC) layer to determine whether information contained in the frame is to be processed by the first adapter by checking whether the multicast address placed in the destination address field of the frame matches an address contained in an address table stored in the first adapter.

12. The system of claim 10, wherein the centralized access point further comprises:
a gateway supporting communications with a network; and
the gateway bridge in communication with the gateway over a plurality of voice channels including the voice channels associated with the at least two logical groups.

13. The system of claim 8, wherein the specified multicast address is unique to the one of the at least two logical groups.

14. The system of claim 8, wherein a first adapter of the plurality of adapters may be a member of all of the at least two logical groups.

15. The system of claim 12, wherein the network communicatively coupled to the gateway of the centralized access point is the Internet.

16. The system of claim 8, wherein the data bandwidth usage is equal to a number of users multiplied by a data rate.
